(19) United States
(12) Patent Application Publication
(10) Pub. No.: US 2007/0058838 A1
(43) Pub. Date: Mar. 15, 2007

(54) Object position detecting apparatus, map creating apparatus, autonomous mobile apparatus, object position detecting method, and computer program product for object position detection

(75) Inventor: Yasuhiro Taniguchi, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/486,119

(22) Filed: Jul. 14, 2006

(30) Foreign Application Priority Data
Sep. 13, 2005 (JP) 2005-265680

(51) Int. Cl. G06K 9/00

(52) U.S. Cl. 382/103; 382/106

(57) ABSTRACT

An object position detecting apparatus includes range sensors, each sensing an object within a sensing region and obtaining an object information indicating existence of the object, image capturing units, each capturing an image data for the sensing region, a distance calculating unit that calculates approximate values of distances from the respective range sensors to the object using the object information and a position determing unit that determines a candidate region where the object exists in the image data based on the approximate values of the distances, and determines a position of the object in the image data by performing image processing of the image data and evaluating a result of the image processing based on a different predetermined threshold between an inside and an outside of the candidate region.

### CROSS-REFERENCE TO RELATED APPLICATIONS

This application is based upon and claims the benefit of priority from the prior Japanese Patent Application No. 2005-265680, filed on Sep. 13, 2005; the entire contents of which are incorporated herein by reference.

### BACKGROUND OF THE INVENTION

1. Field of the Invention

The present invention relates to an object position detecting apparatus that stably detects a position of an object in an arbitrary region by integrating respective data obtained from a range sensor and an image capture unit, a map creating apparatus that generates map data based on a position of an object, an autonomous mobile apparatus, an object position detecting method, and a computer program product for object position detection.

2. Description of the Related Art

According to a conventional technique as disclosed in “Vision for Mobile Robots Considering Uncertainties and Its Planning” by Jun Miura and Yoshiaki Shirai, IPSJ (Information Processing Society of Japan) Transaction, Vol.44, No. SIG17 (CVIM8), pp. 37-49, 2003 (hereinafter referred to as “first related art”), an autonomous mobile robot (hereinafter, referred to as “mobile robot”), has a range sensor such as an ultrasonic sensor or a laser range finder and an image capture unit such as a TV camera as sensors for taking in external information around the robot, and performs an action such as movement based on the information obtained from these various types of sensors. A gist of the first related art is that data is obtained and processed on each sensor separately, and that final processing results of respective sensors are utilized for the improvement of accuracy of the recognition of the surroundings.

According to another related art (hereinafter referred to as second related art) disclosed in Japanese Patent Application Laid-Open No. H7-116981, the mobile robot is guided and controlled based on a comprehensive recognition of a surrounding environment, and the comprehensive recognition is obtained as an integration of sensor data acquired from plural sensors of different types.

In the first related art, the data from plural sensors are integrated for the detection of,the positions of obstacles or the like. The integration of data, however, is performed after the sensor-based processing. The data from each of the sensors is individually processed and based on each of the processing results, a position of an obstacle is detected and map data are generated. After the sensor-based processing, the plurality of processing results and the plurality of pieces of map data are integrated. However, data characteristics are different from one sensor to another. Hence, when the data obtained as a result of the processing are integrated without consideration of the sensor characteristics, the resulting map of the surroundings tends to include many errors.

Particularly, the technique in which data from each of the sensors is individually processed and the resulting maps of the surroundings are integrated is disadvantageous, since the difficulties in map alignment during the process results in a map of the surroundings with insufficient accuracy, and in addition, the advantages of respective sensors are not fully utilized.

Furthermore, in the second related art, although the integration of the sensor data obtained from the plurality of sensors of the different types is performed, the sensor data is evaluated independently and merely combined together, so that the surroundings of the object can be hypothetically known. The plural pieces of sensor data are not actually associated with each other to facilitate the detection of the position of the object. Therefore, the second related art is also disadvantageous in that the characteristics of the respective sensors cannot be taken into consideration in the position detection of the object, resulting in an error in the detected position of the object.

### SUMMARY OF THE INVENTION

According to one aspect of the present invention, an object position detecting apparatus includes range sensors, each sensing an object within a sensing region and obtaining an object information indicating existence of the object,image capturing units, each capturing an image data for the sensing region, a distance calculating unit that calculates approximate values of distances from the respective range sensors to the object using the object information; and a position determing unit that determines a candidate region where the object exists in the image data based on the approximate values of the distances, and determines a position of the object in the image data by performing image processing of the image data and evaluating a result of the image processing based on a different predetermined threshold between an inside and an outside of the candidate region.

According to another aspect of the present invention, a map creating apparatus includes range sensors, each sensing an object within a sensing region and obtaining an object information indicating existence of the object; image capturing units, each capturing an image data for the sensing region; a distance calculating unit that calculates approximate values of distances from the respective range sensors to the object using the object information, a position determing unit that determines a candidate region where the object exists in the image data based on the approximate values of the distances, and determines a position of the object in the image data by performing image processing of the image data and evaluating a result of the image processing based on a different predetermined threshold between an inside and an outside of the candidate region, and a map generating unit that generates map data of a vicinity of a position of the map creating apparatus by ensuring consistency of the position of the object detected by the position detecting unit as time series.

According to still another aspect of the present invention, an autonomous mobile apparatus includes range sensors, each sensing an object within a sensing region and obtaining an object information indicating existence of the object; image capturing units, each capturing an image data for the sensing region; a distance calculating unit that calculates approximate values of distances from the respective range sensors to the object using the object information; a position determing unit that determines a candidate region where the object exists in the image data based on the approximate values of the distances, and determines a position of the object in the image data by performing image processing of the image data and evaluating a result of the image processing based on a different predetermined threshold between an inside and an outside of the candidate region, and a movement controlling unit that controls a movement of the autonomous mobile apparatus so as to avoid the object, based on the position of the object detected by the position detecting unit as time series.

According to still another aspect of the present invention, an autonomous mobile apparatus includes range sensors, each sensing an object within a sensing region and obtaining an object information indicating existence of the object,image capturing units, each capturing an image data for the sensing region, a distance calculating unit that calculates approximate values of distances from the respective range sensors to the object using the object information, a position determing unit that determines a candidate region where the object exists in the image data based on the approximate values of the distances, and determines a position of the object in the image data by performing image processing of the image data and evaluating a result of the image processing based on a different predetermined threshold between an inside and an outside of the candidate region, a map generating unit that generates map data of a vicinity of a position of the autonomous mobile apparatus by ensuring consistency of the position of the object detected by the position detecting unit as time series, and a movement controlling unit that controls a movement of the autonomous mobile apparatus so as to avoid the object, based on the map data generated by the map generating unit.

According to still another aspect of the present invention, an object position detecting method includes calculating approximate values of distances to an object sensed by range sensors each sensing the object within a sensing region and obtaining an object information indicating existence of the object; and determining a candidate region where the object exists in the image data by image capturing units each capturing the image data for the sensing region, based on the approximate values of the distances, and determining a position of the object in the image data by performing image processing of the image data and evaluating a result of the image processing based on a different predetermined threshold between an inside and an outside of the candidate region.

A computer program product according to still another aspect of the present invention causes a computer to perform the method according to the present invention.

### BRIEF DESCRIPTION OF THE DRAWINGS

FIG. 1 is a block diagram showing a functional configuration of a mobile robot according to a first embodiment;

FIG. 2 is a schematic diagram showing a reachable range of an ultrasonic wave of an ultrasonic sensor;

FIG. 3 is a schematic diagram showing reachable ranges of ultrasonic waves emitted from five ultrasonic sensors connected to the mobile robot of the first embodiment;

FIG. 4 is a flowchart showing a procedure of map generation processing by the mobile robot according to the first embodiment;

FIG. 5 is a flowchart showing a procedure of obstacle position detection processing by an obstacle position detecting unit;

FIG. 6 is a schematic diagram showing reachable ranges of ultrasonic waves emitted from the ultrasonic sensors disposed at angles of 0°, 45°, and 90°;

FIG. 7A is a schematic diagram showing reachable ranges of ultrasonic waves emitted from the ultrasonic sensors;

FIG. 7B shows image data acquired by image capture cameras when the mobile robot reaches the vicinity of a corner of walls intersecting at 90° as shown in FIG. 7A;

FIG. 8A is a schematic diagram showing reachable ranges of ultrasonic waves emitted from the ultrasonic sensors;

FIG. 8B shows image data acquired by the image capture cameras when the mobile robot reaches the vicinity of a corner of walls intersecting at 90° as shown in FIG. 8A;

FIG. 9A is a schematic diagram showing reachable ranges of ultrasonic waves emitted from the ultrasonic sensors;

FIG. 9B shows image data acquired by the image capture cameras when the mobile robot reaches the vicinity of a corner of walls intersecting at 90° as shown in FIG. 9A;

FIG. 10A is a schematic diagram showing reachable ranges of ultrasonic waves emitted from the ultrasonic sensors;

FIG.10B shows image data acquired by the image capture cameras when the mobile robot reaches the vicinity of a corner of walls intersecting at 90° as shown in FIG. 10A;

FIG. 11A is a schematic diagram showing reachable ranges of ultrasonic waves emitted from the ultrasonic sensors when one ultrasonic sensor is placed so as to emit ultrasonic waves in a direction of 45°;

FIG. 11B shows image data acquired by the image capture cameras in a state as shown in FIG. 11A;

FIG. 12 is a schematic view showing an example of image data when there are clear differences in color and brightness between walls;

FIG. 13 is an explanatory view showing an example of image data obtained by capturing an image of two walls which are analogous to each other in brightness and color;

FIG. 14A is a schematic diagram showing an example where the mobile robot moves parallel to a wall;

FIG. 14B shows image data acquired by the image capture cameras when the mobile robot is in a state as shown in FIG. 14A;

FIG. 15A is a schematic diagram showing an example where the mobile robot moves in a direction not parallel to a wall;

FIG. 15B shows image data acquired by the image capture cameras when the mobile robot is in a state as shown in FIG. 15A;

FIG. 16A is a schematic diagram showing an example of reachable ranges of ultrasonic waves emitted from the ultrasonic sensors when the mobile robot moves in the direction not parallel to the wall and the side direction of the mobile robot forms an oblique angle α with respect to the front wall;

FIG. 16B shows image data acquired by the image capture cameras when the mobile robot is in a state as shown in FIG. 16A;

FIG. 17 is an explanatory diagram showing one example of inclination data;

FIG. 18 is an explanatory diagram showing one example of position data;

FIG. 19 is a block diagram showing a functional configuration of a mobile robot according to a second embodiment;

FIG. 20 is a schematic diagram showing a relation between the image capture cameras and a point P(X,Y,Z) on a corner;

FIGS. 21 and 22 are schematic diagrams showing a state of edge detection when a disparity is utilized to determine a search range;

FIG. 23 is a block diagram showing a configuration of a map creating apparatus according to a third embodiment; and

FIG. 24 is a block diagram showing a configuration of an obstacle position detecting apparatus according to a fourth embodiment.

### DETAILED DESCRIPTION OF THE INVENTION

Hereinafter, referring to the accompanying drawings, preferred embodiments of an object position detecting apparatus, a map creating apparatus, an autonomous mobile apparatus, an object position detecting method, and a computer program product for object position detection according to the invention are described in detail.

In a first and a second embodiments, the object position detecting apparatus, the map creating apparatus, the autonomous mobile apparatus, the object position detecting method, and the computer program product for object position detection of the present invention are applied to an autonomous mobile robot (also referred to as “mobile robot”) which can move by autonomous traveling. It should be noted, however, that the present invention is not limited to the mobile robot, and the object position detecting apparatus, the map creating apparatus, the autonomous mobile apparatus, the object position detecting method, and the computer program product for object position detection according to the present invention can be applied to any apparatus that includes a range sensor and an image capture unit.

When the present invention is applied to the mobile robot, the mobile robot is configured so as to include a map creating unit that creates a map based on an output from an obstacle position detecting unit, and a drive controlling unit that controls movement based on the created map. The object position detecting apparatus of the present invention is, however, applicable to various systems depending on configurations of the pertinent systems; for example, the object position detecting apparatus of the present invention can be applied to a system that merely calculates the position of an obstacle, or a system that merely creates a map based on the position of an obstacle.

First, the first embodiment is described.

A mobile robot 100 according to the first embodiment autonomously moves within a predetermined movement region (sensing region) to detect a position of an obstacle within the movement region.

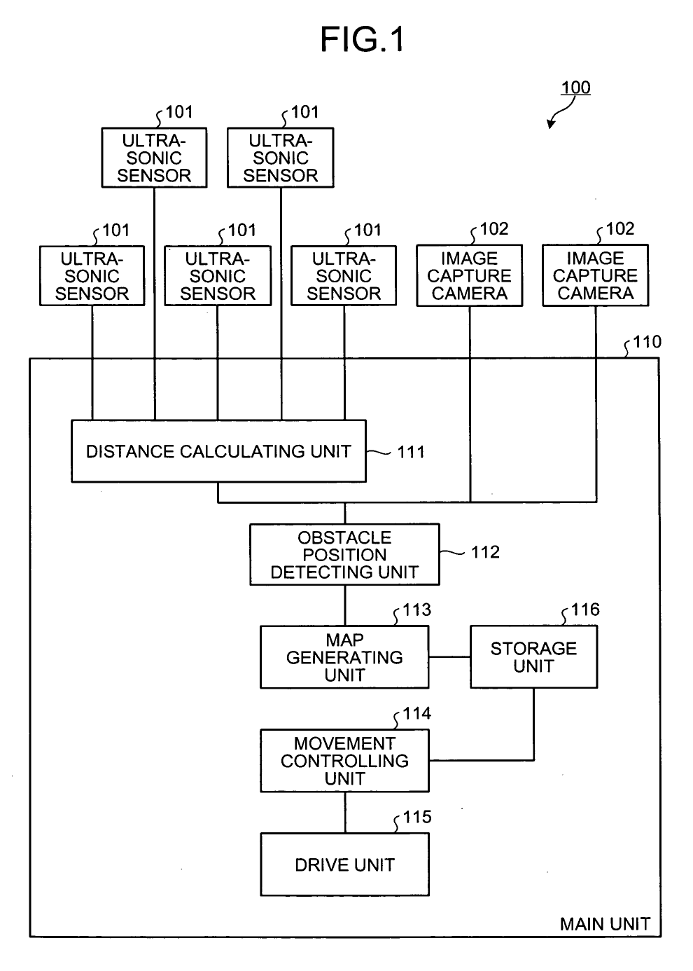

FIG. 1 is a block diagram showing a functional configuration of the mobile robot according to the first embodiment. As shown in FIG. 1, the mobile robot 100 according to the present embodiment mainly includes a main unit 110, five ultrasonic sensors 101 that are connected to the main unit 110 and serve as range sensors, and two image capture cameras 102 that serve as image capture units. The numbers of the ultrasonic sensors and the image capture units are determined based on the accuracy of each sensor and the extent of a range required to be measured, and the numbers employed in the embodiment is not limiting.

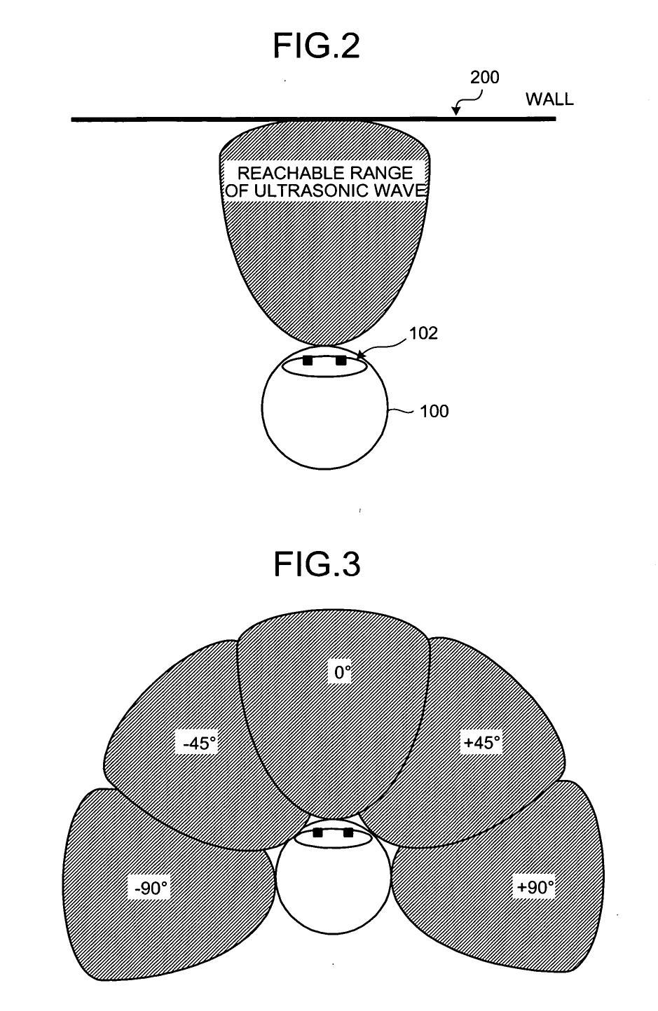

The ultrasonic sensor 101 is a range sensor which irradiates an obstacle with an ultrasonic pulse and receives a reflected pulse thereof. The ultrasonic sensor 101 senses an obstacle within a sensing region set around the mobile robot 100 by the irradiation of an ultrasonic wave. FIG. 2 is a schematic diagram showing a reachable range of the ultrasonic wave of the ultrasonic sensor. As shown in FIG. 2, since the ultrasonic wave emitted by the ultrasonic sensor generally spreads as propagates, the horizontal resolution is low. Hence, the ultrasonic sensor is mostly used to simply decide whether there is an obstacle in front of the ultrasonic sensor or not. The ultrasonic sensor 101, however, can measure the distance in the depth direction with a favorable degree of accuracy depending on the wavelength of the ultrasonic wave. Generally, the ultrasonic sensor 101 can measure the distance to accuracy of approximately a few centimeters, though the accuracy varies according to the distance from a sensed object to the ultrasonic sensor.

FIG. 3 is a schematic diagram showing reachable ranges of the ultrasonic waves emitted from the five ultrasonic sensors 101 connected to the mobile robot 100 of the first embodiment. In the mobile robot 100 of the first embodiment, the five ultrasonic sensors 101 are arranged at angle intervals of 45° from side surfaces of the mobile robot 100 to a front surface thereof.

As described later, since a corner position in image data is uniquely determined by a ratio between a distance to a front wall and a distance to a side wall instead of depending on absolute values of the distances, the ultrasonic sensors are placed on a front side, a right side, and a left side of the mobile robot in the first embodiment. Furthermore, in the mobile robot 100 according to the first embodiment, the ultrasonic sensors 101 are placed so as to emit the ultrasonic waves in oblique directions of ±45° in order to improve the accuracy of estimation of the corner position in the image which is decided depending on the distances. Further, to deal with a possible backward movement of the mobile robot 100, the ultrasonic sensor 101 and the image capture camera 102 may be arranged so as to emit the ultrasonic wave backward.

While it is possible to arrange more than five ultrasonic sensors 101 in the mobile robot, the number of the ultrasonic sensors 101 is generally not proportional to the degree of accuracy of the estimation, since the ultrasonic wave emitted from the ultrasonic sensor 101 has a property of spreading during propagation. However, if the ultrasonic wave does not spread much during propagation, the arrangement of more ultrasonic sensors 101 at smaller angle intervals may contribute to the improvement in accuracy of distance estimation.

Furthermore, though the range sensor employed in the first embodiment is the ultrasonic sensor, which is not a limiting example and any sensor such as a range finder can be utilized as the range sensor as far as the sensor can measure the distance. The image capture camera is intended to capture an image in the movement region, and, for example, a TV camera or the like can be used.

As shown in FIG. 1, the main unit 110 mainly includes a distance calculating unit 111, an obstacle position detecting unit 112, a map generating unit 113, a movement controlling unit 114, a drive unit 115, and a storage unit 116.

The distance calculating unit 111 calculates an approximate value of a distance from the mobile robot 100 to an obstacle using a reflected wave received by the ultrasonic sensor 101. The distance calculating unit 111 calculates the approximate value of the distance for each ultrasonic sensor 101.

The obstacle position detecting unit 112 determines a search range (candidate region) using the approximate value of the distance calculated by the distance calculating unit 111 and the image data captured by the image capture unit 102 from the movement region. The search range is a region, which appears in the image data captured by the image capture unit 102, and in which an obstacle is expected to exist. Then, the obstacle position detecting unit 112 detects the position of the obstacle from the image data using a threshold varied between the inside and the outside of the search range. More specifically, the search area is set in a certain image data range in which the obstacle is predicted to be positioned in the image data according to the approximate value of the distance calculated by the distance calculating unit 111. The obstacle position detecting unit 112 performs image processing inside the search range, and specifies the obstacle based on the results of image processing using the predetermined thresholds as a part of the image processing, thereby detecting the position of the obstacle. If no obstacle can be detected inside the search range, the search range is set again in a larger area in the image data. Then, the obstacle position detecting unit 112 specifies the obstacle, or specifies the obstacle by using a different threshold from the above-mentioned threshold outside the search range, thereby performing the position detection.

In some cases, the search range cannot be uniquely determined due to the insufficient accuracy of the ultrasonic sensors. In such case, the regions of the optional number are set and the degrees of reliability are defined for each region. The thresholds for the image processing are adjusted according to the defined degrees of reliability. Then, a more precise integrated processing can be performed on the sensor information.

Generally, the distance data acquired from the ultrasonic sensors has many noises, and hence a relatively low reliability. Furthermore, since the ultrasonic wave has the property of spreading during propagation as shown in FIG. 2, if plural obstacles with sufficient sizes exist in the movement region, only a distance from the mobile robot to the nearest obstacle is acquired. To alleviate such inconveniences, the mobile robot 100 of the first embodiment analyzes the image data obtained by the image capture cameras 102 to specify the obstacle located at the position corresponding to the approximate values of the distances found from the sensor data of the ultrasonic sensors 101.

In other words, in the present embodiment, both of the approximate values of the distances obtained from the ultrasonic sensors 101 and the image analysis of the image data are mutually utilized at an intermediate stage of the obstacle detection to perform precise position detection of the obstacle, so that the advantages of respective characteristics of ultrasonic sensors 101 and the image capture cameras 102 are utilized to perform highly accurate obstacle detection and map generation.

The map generating unit 113 acquires the position of the obstacle detected by the obstacle position detecting unit 112 as sequential data, performs processing such as correction of the acquired position information to ensure the consistency, generates map data of the vicinity of its own position so as to reflect the consistent position information, and stores the generated map data in the storage unit 116. Further, when an obstacle is newly detected, the map generating unit 113 performs the processing of updating the map data by reflecting the position of the newly detected obstacle on the map data stored in the storage unit 116.

The movement controlling unit 114 controls the drive unit so as to move the mobile robot 100 according to the map data. More specifically, the drive unit 115 is controlled so that the mobile robot 100 travels while avoiding the position of the obstacle specified on the map data. The drive unit 115 drives and stops wheels (not shown) of the mobile robot.

The storage unit 116 is a storage medium such as a memory and a hard disk drive (HDD) and stores the above-described map data, and after-described inclination data and position data.

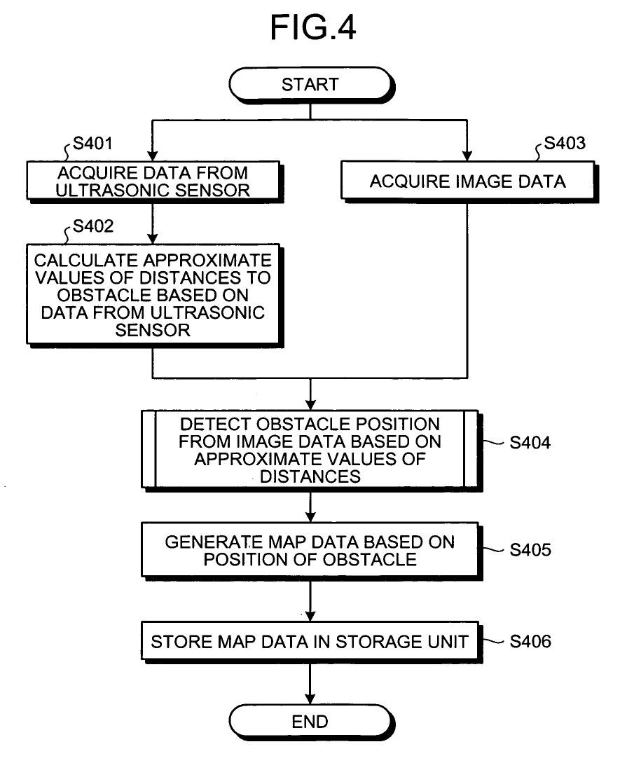

Next, map generation processing by the mobile robot 100 according to the first embodiment configured as mentioned above is described. FIG. 4 is a flowchart showing a procedure of the map generation processing by the mobile robot 100 according to the first embodiment.

Each of the ultrasonic sensors 101 emits a reflected pulse for detecting whether or not an obstacle exists within the movement region, and receives and sends a reflected wave from the obstacle as sensor data. The distance calculating unit 111 acquires the sensor data from the ultrasonic sensors 101 (step S401) and, from the acquired sensor data, calculates an approximate value of a distance to the obstacle for each of the ultrasonic sensors 101 (step S402). On the other hand, the image capture cameras 102 capture images within the movement region and send the image data of still images at constant timing. The obstacle position detecting unit 112 acquires the image data from the image capture cameras 102 (step S403).

Next, in the obstacle position detecting unit 112, the position detection processing of the obstacle is performed from the acquired image data based on the approximate values of the distances by the distance calculating unit (step S404). A detailed description of the position detection processing of the obstacle will be given later. The map reflecting the position of the obstacle obtained by the obstacle position detecting unit 112 is generated (step S405) and stored in the storage unit 116 (step S406).

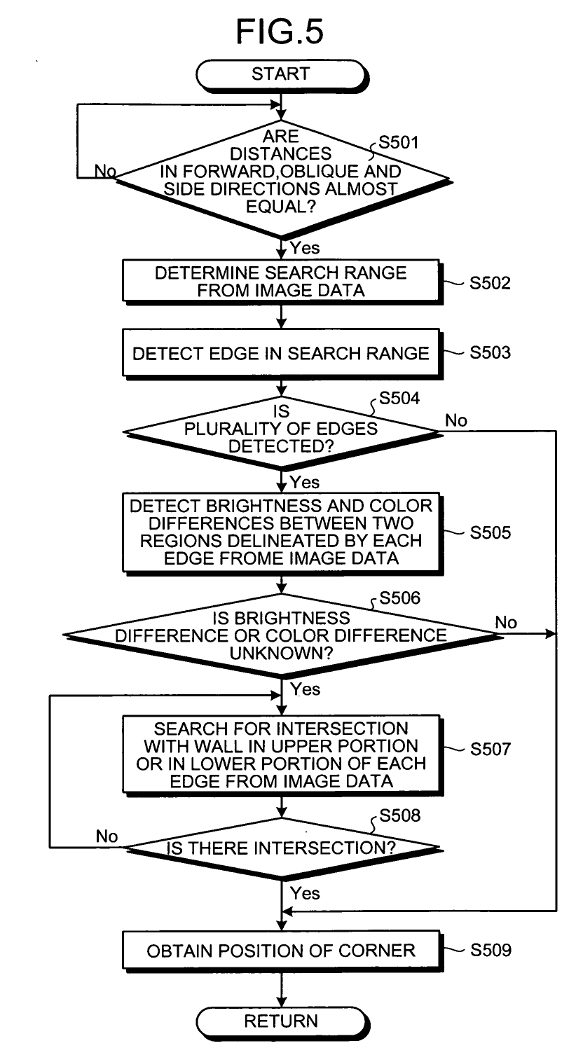

Next, the position detection processing of the obstacle in step S404 is described. FIG. 5 is a flowchart showing a procedure of the obstacle position detection processing by the obstacle position detecting unit 112. Here, as an example of the obstacle position detection, detection of a corner which is a boundary between walls is described.

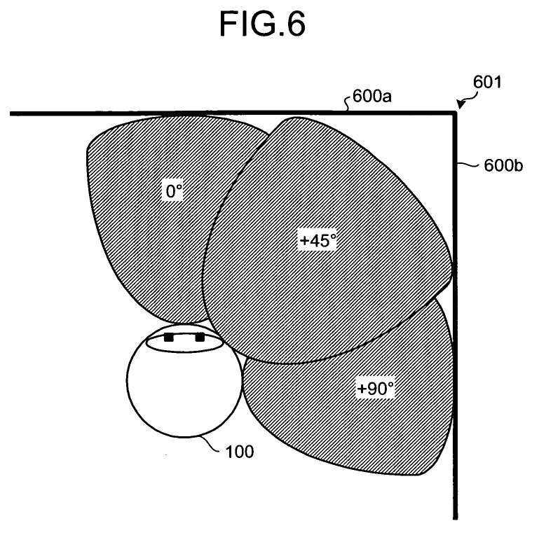

Generally, when creating a map of a room which is the movement region of the mobile robot, a boundary of the room (border of walls and a door) needs to be identified. In particular, a boundary between walls, that is, a corner which is a nodal line of the walls needs to be detected precisely. As described above, however, the ultrasonic wave has the property of spreading during propagation. Hence, when the mobile robot is arranged close to the corner to observe a shape of the corner by the ultrasonic sensors 101, all the sensors mounted respectively at the angle of 0°, 45°, and 90° detect the same distance as shown in FIG. 6, which makes it difficult to identify the position of the corner.

As shown in FIG. 2, if the spread of the ultrasonic wave (fan-like shape of FIG. 2) could be theoretically determined, the position of the corner could be estimated to some extent from values of the distances in three directions. However, since, in practice, many noises are contained in the sensor data from the ultrasonic sensors 101, it is difficult to estimate the position of the corner. Therefore, the approximate values of the distances to the walls obtained from the sensor data of the ultrasonic sensors 101 are utilized to determine the precise position of the corner on the image data.

First, the approximate values of the distances to the obstacle at the respective ultrasonic sensors 101, which are obtained by the distance calculating unit 111, are compared to check whether or not the approximate value of the distance to the obstacle in a forward direction calculated from the ultrasonic sensor 101 of the 0° position, the approximate value of the distance in an oblique direction calculated from the ultrasonic sensor 101 of the 45° position, and the approximate value of the distance in a side direction calculated from the ultrasonic sensor 101 at the +90° position are substantially equal, in other words, whether or not differences of the respective approximate values are in a predetermined range (step S501). The reason why it is checked whether or not the approximate values of the distances in the three directions are almost same is as follows.

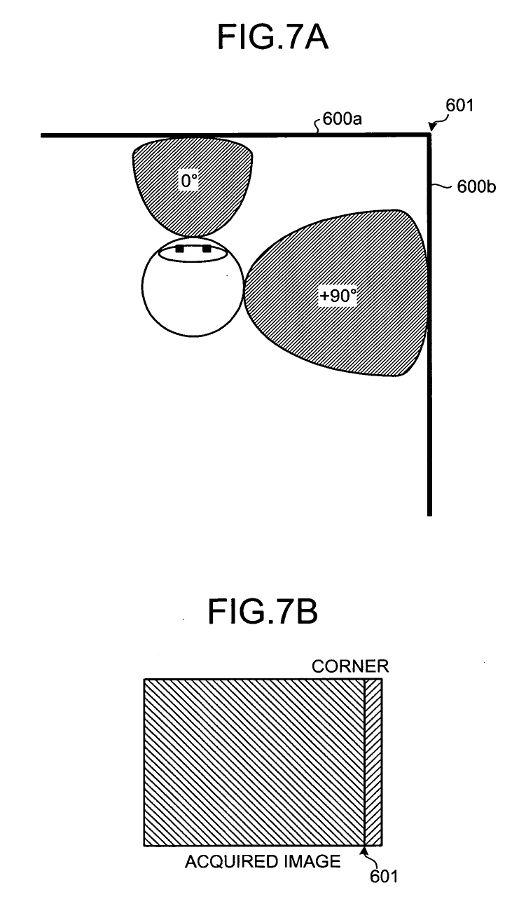

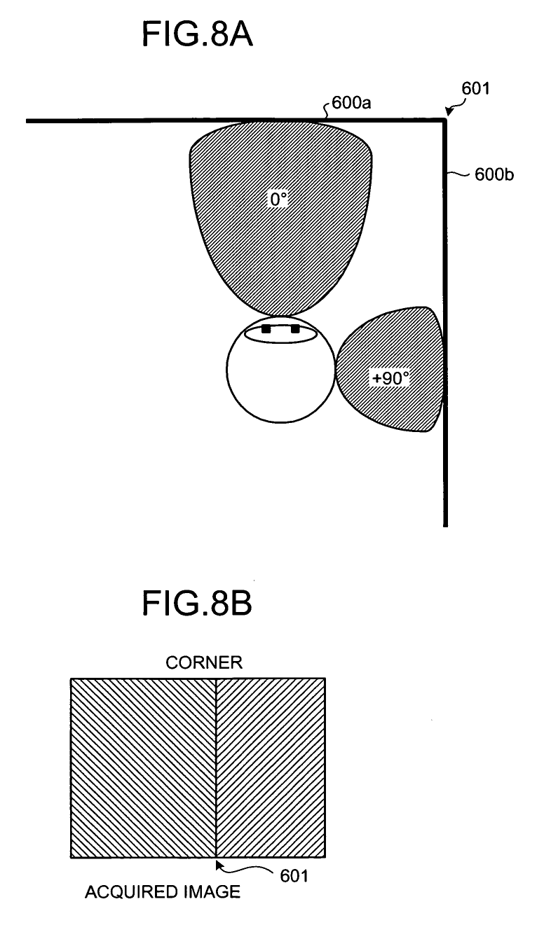

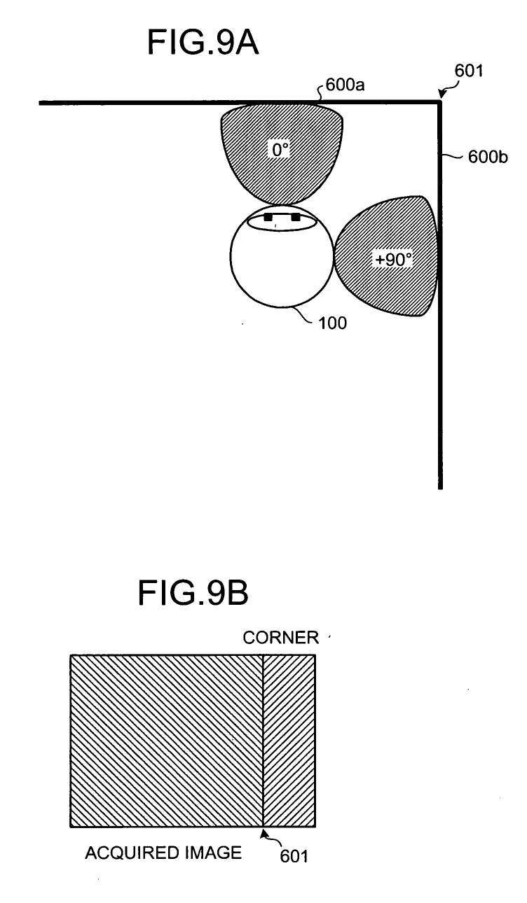

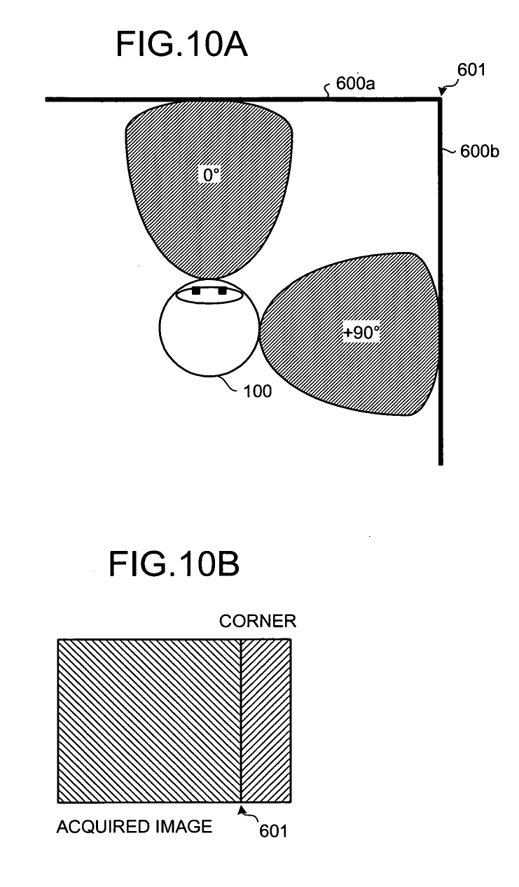

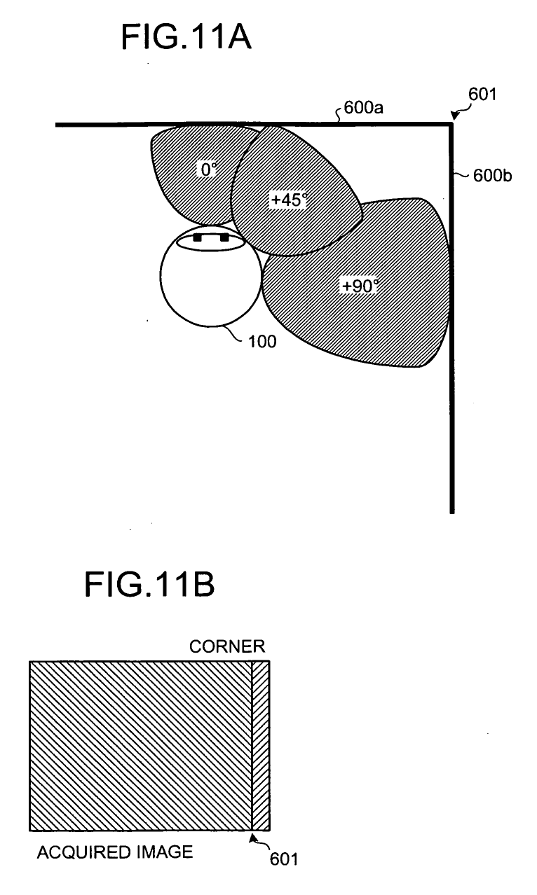

FIGS. 7A, 8A, 9A, and 10A are explanatory diagrams showing the ultrasonic waves emitted from the ultrasonic sensors 101 and FIGS. 7B, 8B, 9B, and 10B show the image data acquired from the image capture cameras 102 when the mobile robot 100 reaches the vicinity of a corner 601 of walls 600a, 600b intersecting at an angle of 90°. FIG. 11A is an explanatory diagram showing the reachable ranges of the ultrasonic waves and FIG. 11B is the image data acquired from the image capture cameras 102 when the ultrasonic sensor 101 is placed so as to emit the ultrasonic wave in the direction of 45°. As shown in FIG. 11A, the distance obtained from the ultrasonic sensor 101 arranged at the position of 45° is a value close to a shorter distance of the distance in the forward direction and the distance in the side direction.

As seen from FIGS. 7B to 10B, the position of the corner 601 in the image data is uniquely determined by a ratio between the distance to the wall 600a in front of the mobile robot 100 and the distance to the side wall 600b, independently of absolute values of the distances. Therefore, in the first embodiment, the ultrasonic sensor 101 is placed not only in one direction, but in five different directions, i.e., the forward, the right, the left, the diagonally forward right, and the diagonally forward left directions, so as to emit ultrasonic wave in these directions.

As can be seen from FIGS. 7B to 10B, when the mobile robot 100 is moving in a parallel direction to the wall 600b, while the front wall 600a positioned in the traveling direction of the mobile robot 100 is not detected by the ultrasonic sensor 101, the sensor data from the ultrasonic sensor 101 facing in the oblique direction of 45° indicates a distance value slightly larger than the distance from the mobile robot 100 to the side wall 600b. It can be seen that if the mobile robot 100 continues to move forward in this state, and the front wall 600a is detected, at first, the distance to the front wall 600a is longer than the distance to the side wall 600b, and the difference between the distances gradually decreases eventually down to zero.

The position where the distance to the front wall 600a and the distance to the side wall 600b are equal is an optimal position for the mobile robot 100 to turn around. At this position, the distance in the oblique direction of +45° is substantially equal to the distances in the forward and side directions. Therefore, in step S501, whether or not the approximate values of the distances in the three directions are substantially equal (that is, whether or not the differences in distances are in a predetermined range) is determined.

In step S501, if it is determined that the approximate values of distances in three directions are not substantially equal (No in step S501), the mobile robot 100 is moved forward until the approximate values of the distances in the three directions are substantially equal. If the distance in the oblique direction is sufficiently longer than the distances in the other directions, there is a high possibility that one of the front and side obstacles is not a wall or neither of them are walls, and thus, the analysis of the image data acquired from the image capture cameras 102 can be advantageously performed.

Furthermore, when ultrasonic sensors each having a relatively small spread of the ultrasonic wave are used, there can occur a situation in which the approximate values of the distances in the three directions do not become equal and that only the distance in the direction of 45° is longer than the forward and side distances. However, in this case, the distance in the direction of 45° is almost constant while the mobile robot is moving forward, and after the mobile robot comes close to the corner, the distance becomes shorter. This is because in the vicinity of the corner, in the sensor in the direction of 45°, at first the distance to the side surface is reflected, while the distance to the front surface is reflected after the point when the distance to the side surface and the distance to the front surface become equal as the mobile robot is moving forward. Therefore, even in the case where the distances of the sensors in the three directions do not become substantially equal, it is understood that the point where the front and side distances become substantially equal and the distance in the direction of 45° begins to decrease is the vicinity of the corner.

On the other hand, in step S501, if the differences of the approximate values of the distances in the three directions are almost equal, that is, if the differences are in the predetermined range (Yes in step S501), there is a high possibility that the relevant point is a corner and thus, the search for the corner is performed. Namely, from the image data acquired from the image capture cameras 102, the vicinity of the position on the image data corresponding to the vicinity of the approximate values of the distances is determined as the search range (step S502). More specifically, since the position where the distances in the three directions are almost equal is a point where there is the highest probability that the corner 601 exists in the oblique direction of 45°, an X-coordinate on the image data of the position in the oblique direction of 45° is obtained and a range of the number of pixels of a predetermined value from the position is determined as the search range on the image data.

For example, if a focal length f of the image capture camera 102 is represented by the number of pixels [Pix], a point on the right side from the center of image by the same number of pixels as the focal length f indicates the direction where an edge which is the corner can exist. If the focal length f of the image capture camera 102 is presented in the SI unit, a physical size of a light receiving surface w[mm], the number of pixels of the light receiving surface y[Pix], and the number of pixels x[Pix] from the center of image data to the corner position have a relation of a following equation (1).
x:f=w:y (1)

Therefore, the number of pixels x[Pix] from the center of the image data to the corner position is calculated by a following equation (2),
x=f·y/w (2)
wherein f is a focal length [mm] of the image capture camera 102, y is the number of pixels of the receiving surface [Pix] and w is the physical size [mm] of the receiving surface.

Similarly, if it is desired to maintain different distances from the side wall 600b to which the mobile robot is moving parallel and from the wall 600a detected in front of the mobile robot 100, the corner position is obtained from the ratio between the desired distances by using the following equation (3),
x=f·(y/w)·(L/L′) (3)
wherein x, f, y, and w are similar to those in the equation (2), and L is a distance to be maintained with respect to the front wall, and L′ is a distance maintained with respect to the side wall.

Though the X-coordinate of the corner position is obtained in the above-describe manner, in practice, thus-obtained coordinate of the corner position is affected by the errors often included in the sensor data of the respective ultrasonic sensor 101. Therefore, in the present embodiment, the predetermined range centering the X-coordinate of the corner position is set as the search range. The edge is searched for within the search range thus set (step S503). The predetermined range to be applied at the setting of the search range may be set based on an expected error, which is previously determined, in the sensor data of the ultrasonic sensor.

The detection of the edge is performed here because the normal direction in the flat surface is converted at the nodal line where the two walls intersect even in the case where wall paper of the same material is used, so that a strong edge often appears at the nodal line portion on the image data. The edge portion thus detected is specified as the corner position.

The detection of the edge is performed, for example, by providing an edge detection filter such as Sobel filter in the obstacle position detecting unit 112, and searching for a strong edge in the vertical direction. Here, for the edge detection filter, any filter that is applicable to an edge in the vertical direction, such as a differential filter, may be used.

Then, it is determined whether or not plural edges is detected in the search range (step S504), and if the plural edges is not detected (No in step S504), that is, if one edge is detected, then the detected edge is specified as a corner and the position of the corner is obtained as a pixel value from the center position of the image data (step S509).

On the other hand, if the plural edges is detected within the search range (Yes in step S504) in step S504, to determine the difference in characteristic between the two regions of the image data delineated by the edge, a brightness difference and a color difference between two regions are detected for each of the edges (step S505).

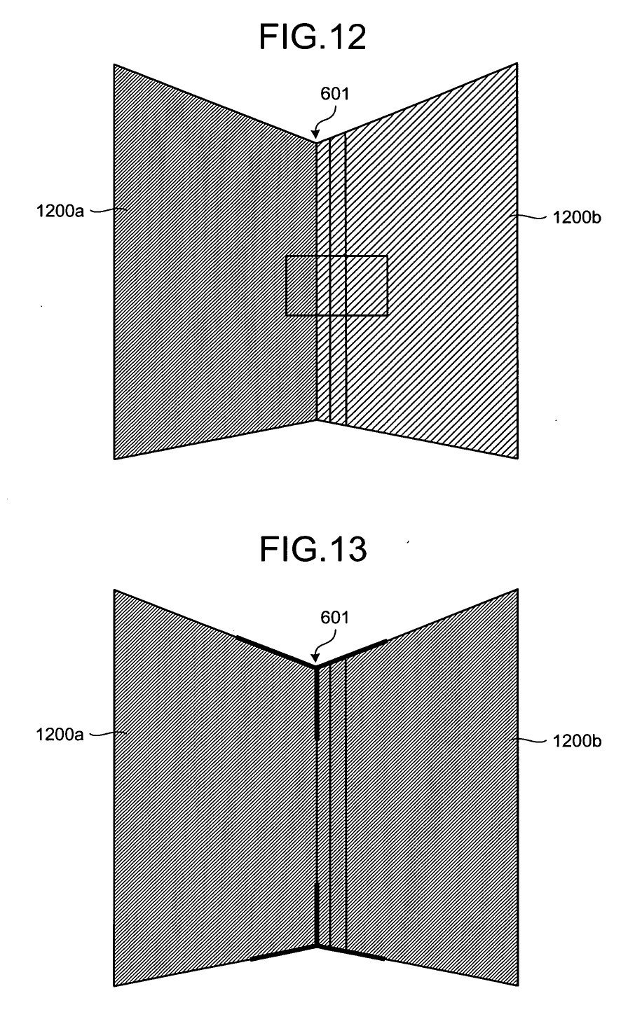

FIG. 12 is a schematic diagram showing an example of the image data where obvious differences in color and brightness between a wall 1200a and a wall 1200b exist. As shown in FIG. 12, when there are obvious differences in color and brightness between the two walls 1200a and 1200b, the edge with the largest differences in color and brightness between the two regions on the image data is selected and specified as a corner.

Therefore, whether or not the color difference and the brightness difference between the two regions are undetectable and unknown is determined (step S506). More specifically, it is checked whether or not the brightness difference and the color difference between the two regions are larger than the predetermined thresholds, and if the differences are larger, it is determined that the brightness difference and the color difference between the two regions can be detected, whereas if the differences are smaller, it is determined that the brightness difference and the color difference between the two regions cannot be detected. Further, if the brightness difference and the color difference between the two regions can be detected (No in step S506), the edge of the boundary between the two regions where the brightness difference and the color difference can be detected is specified as a corner, and the position of the corner is set to a pixel value from the center position of the image data or its position coordinate (step S509).

Though the color and the brightness are used as the characteristics of the regions representing the walls in the image data in the present embodiment, the characteristics are not limited to them, but any characteristic value by which an edge can be specified may be used.

The brightness difference and the color difference, which are differential characteristics, tends to be affected by noises. Hence, the thresholds for detection cannot be largely decreased in the normal image processing. Though in the present embodiment, the search range of the edge is defined according to the approximate values of the distances, alternatively, the search range may be controlled to be extended or reduced or the threshold is controlled to vary according to the position within the search range. Such manners of control are advantageous in that an edge or the like where the brightness difference and/or the color difference are smaller can be detected depending on the region, which is the search range, in the image data.

Furthermore, the search range is divided into plural regions according to the probability that an edge exists, and by decreasing the thresholds utilized in a region with higher existing probability, the edge indicated from information from another sensor can be detected with high accuracy.

On the other hand, in step S506, if in any of the edges, neither the brightness difference nor the color difference between the two regions can be detected even after the control of the thresholds has been performed (Yes in step S506), then the search range in the image data is extended upward and downward to search for an intersection with the wall in the upper portion and the lower portion of the edge (step S507).

FIG. 13 is an explanatory diagram showing an example of image data obtained by capturing an image of the two walls 1200a and 1200b, which are analogous to each other in brightness and color. As shown in FIG. 13, the edge as a nodal line of the walls appears in a Y shape or in an inverted Y shape at the upper end or the lower end of the edge. Therefore, in the present embodiment, the state of the upper portion or the lower portion of the edge is observed to search for the existence of an intersection appearing in a Y shape or in an inverted Y shape. Thus, when the brightness difference and the color difference in the image data are unclear or when the edge itself is vague, the edge, which is a corner, can be specified with higher accuracy through the search for an intersection in the upper portion and the lower portion of the edge. Though the intersection is searched for in either the upper portion or the lower portion of the edge in the present embodiment, alternatively the intersection can be searched for in both the upper portion and the lower portion.

Accordingly, whether or not an intersection with the wall exists in the upper portion or the lower portion of the edge is determined (step S508), and if no intersection exists (No in step S508), an intersection with the wall is searched for in the upper or the lower portion of the next edge (step S507).

On the other hand, in step S508, if an intersection with the wall exists in the upper portion or the lower portion of the edge (Yes in step S508), the edge where the intersection with the wall exists is specified as a corner and the position of the corner is set to a pixel value from the center position of the image data or a position coordinate (step S509). This processing allows the corner position to be obtained with high accuracy.

Meanwhile, if the corner cannot be detected inside the above-described search range, the corner is detected outside of the search range. In this case, whether or not the brightness difference and the color difference between the two regions can be detected is determined by different thresholds from the thresholds applied to the inside of the above-described search range; for example, thresholds of larger values than the thresholds applied to the inside of the above-described search range are employed.

While, in the above-described obstacle position search processing, the case where the mobile robot 100 moves parallel to the side wall is described, hereinafter, the obstacle position detection processing which is performed when the mobile robot 100 moves in a direction not parallel to the wall is described.

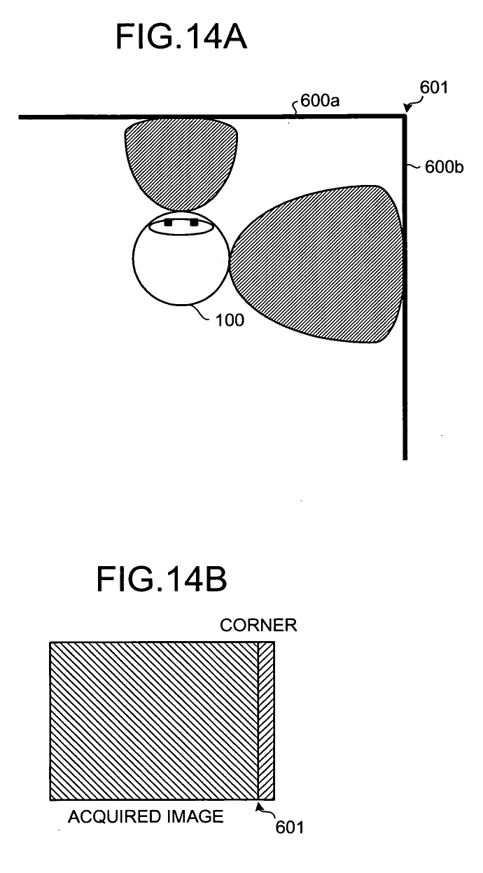

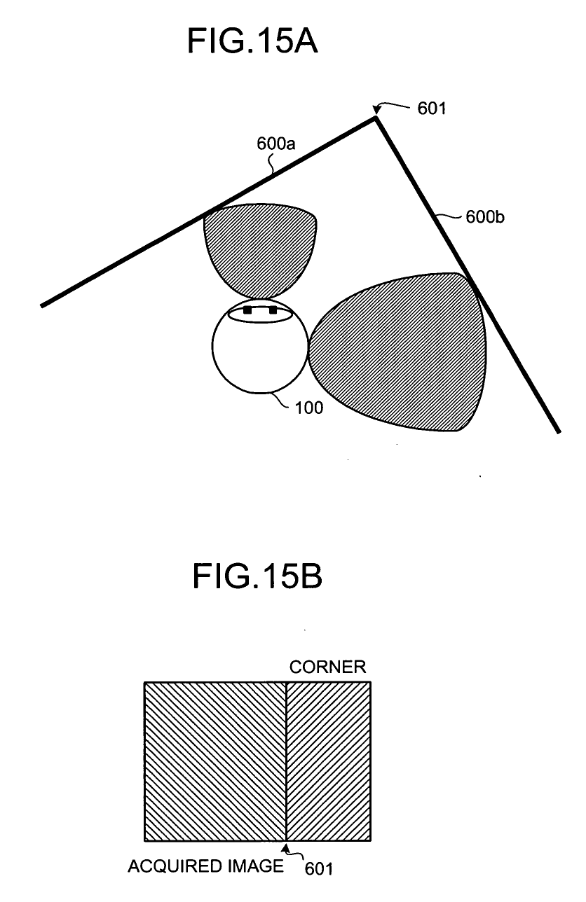

FIG. 14A is a schematic diagram showing an example where the mobile robot 100 moves parallel to the wall 600b, and FIG. 15A is a schematic diagram showing an example where the mobile robot 100 moves in a direction not parallel to the wall 600b. As can be seen from the reachable ranges of the ultrasonic waves of FIGS. 14A and 15A, if only the data from the ultrasonic sensors 101 are used for the detection, the distance from the mobile robot 100 to the front wall and the distance to the side wall 600b have the same values both in the case where the mobile robot moves parallel to the wall 600b and in the case where the mobile robot moves in the direction not parallel to the wall 600b, and an identical position may be detected as the positions of the corners in both cases. However, the observation of the captured image data (FIGS. 14B and 15B) shows that the position of the corner 601 is different in the image data for two cases; the position of the corner in the case where the mobile robot 100 moves in the direction not parallel to the wall 600b (FIG. 15A) exists on the relatively left side in comparison with the case where the mobile robot 100 moves parallel to the wall 600b (FIG. 14A).

Consequently, in the present embodiment, when the search range is determined in the above-described step S502, the inclination data and the position data stored in the storage unit 116 are used to obtain the X-coordinate of the corner position and determine the search range.

In the inclination data, a correlation between a ratio of the distance to the front wall 600a and the distance to the side wall 600b and an oblique angle α of the mobile robot 100 with respect to the wall 600a is determined in advance.

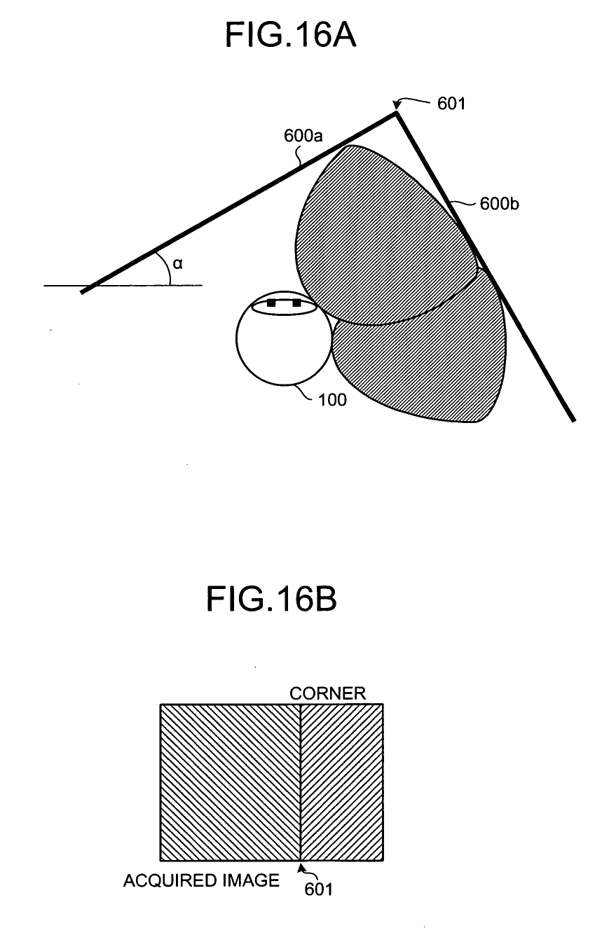

FIG. 16A is an explanatory diagram showing one example of reachable ranges of the ultrasonic waves from the ultrasonic sensors, and FIG. 16B shows the image data where the mobile robot 100 moving in a direction not parallel to the wall 600b forms the oblique angle α with respect to the front wall 600a. As shown in FIG. 16A, if the above-described inclination data has been obtained in advance, the oblique angle α can be estimated from a value of the distance in the direction of 45°. Namely, as shown in FIG. 16A, when the mobile robot 100 moves at the oblique angle α with respect to the front wall 600a, as the oblique angle α becomes larger, the distance in the direction of 45° becomes longer and the position of the corner becomes closer to the center of the image data.

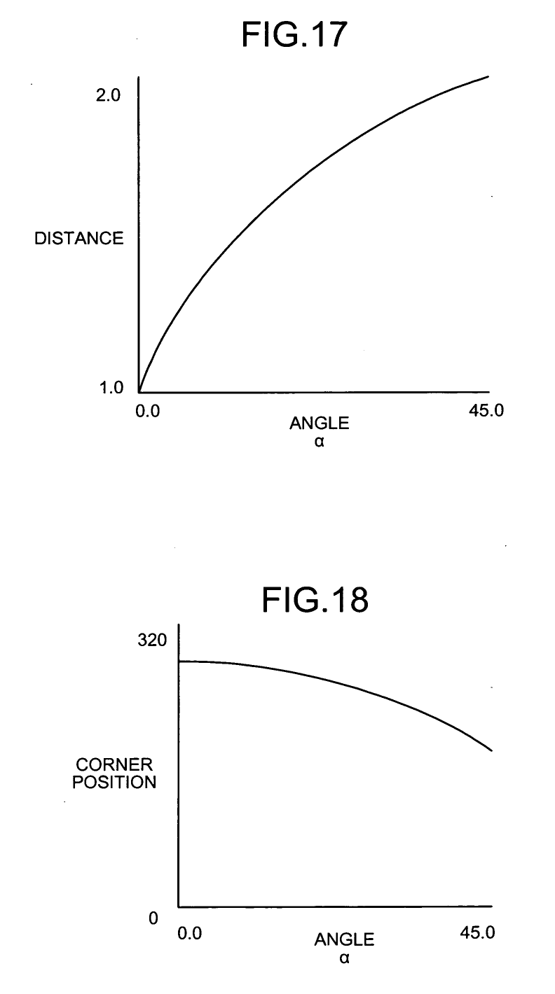

Therefore, the characteristics of the ultrasonic sensors are checked in advance and the correlation between the oblique angle and the change in distance is obtained to be stored as the inclination data, which allows the search range of the corner position to be easily determined. FIG. 17 is an explanatory diagram showing one example of the inclination data. The position of the corner is determined only by the ratio between the distance to the front wall 600a and the distance to the side wall 600b and the angle α of the wall. As shown in FIG. 17, if the distance to the front wall 600a is 1.0 unit, for example 1.0 [m], and the distance to the side wall 600b is 2.0 units,for example 2.0 [m], and when the oblique angle α with respect to the wall 600a is given in a range of 0° to 45°, the distance in the direction of 45° is changed as shown in FIG. 17.

Furthermore, FIG. 18 is an explanatory diagram showing one example of the position data. In the position data, a correlation between the oblique angle α and the position of the corner in the image data is determined in advance. Namely, in the case where the mobile robot 100 moves in the direction not parallel to the wall 600b, in step S502, the oblique angle α is obtained from the approximate values of the distances by the ultrasonic sensors by referring to the inclination data of FIG. 17 and the position of the corner is obtained from the oblique angle α by referring to the position data of FIG. 18. Further, a predetermined range centering this corner position is determined as the search range, which enables the precise search of the corner. The processing in step S503 and later is performed similar to the position detection processing in the case where the mobile robot 100 moves parallel to the wall 600b.

In the mobile robot 100 according to the first embodiment, the approximate values of the distances to the obstacle sensed by the ultrasonic sensors 101 are calculated, the search range where the obstacle can exist is determined based on the calculated approximate values of the distances to the obstacle and the image data captured by the image capture cameras 102, and the position of the obstacle is detected from the image data within the search range to generate the map data of the movement region. Accordingly, in comparison with the conventional method in which map data is generated separately based on the data from the range sensors and the image data acquired from the image capture units and later the respective pieces of the map data are integrated, the characteristics of the respective sensors can be utilized and thus, a higher accuracy map can be generated. Namely, the sensor data from the sensors having different characteristics can be effectively integrated and thus, highly reliable position detection of an obstacle is enabled. Therefore, when highly reliable obstacle information cannot be acquired in the mobile robot, a technique of slightly moving the mobile robot to redetect the obstacle can be employed, which allows a more accurate map data to be generated.

Thus, in the mobile robot 100 according to the first embodiment, the approximate values of the distances to the obstacle are obtained from the ultrasonic sensors 101 and from the approximate values, the search range where an object is expected to exist is set in the image data from the image capture units, and further, by using the thresholds varied between the inside and the outside of the search range, the position of the object is detected from the image data and the approximate values of the distances. In other words, based on the characteristics of the ultrasonic sensors 101 and the image capture cameras 102, the data from the ultrasonic sensors 101 and the image capture cameras 102 are mutually utilized at an intermediate stage of obstacle detection to detect the actual position of the object. Accordingly, in comparison with the related art in which after the positions of the object are detected separately from the distance data from the obstacles sensed by the respective ultrasonic sensors 101 and the image data acquired from the respective image capture cameras 102, the position information of the object is integrated, the characteristics of the ultrasonic sensors 101 and the image capture cameras 102 are utilized more effectively, thereby allowing highly accurate position detection of the object such as the obstacle.

Furthermore, as a result, in the mobile robot 100 according to the first embodiment, a high accuracy map of the surrounding region can be created. Furthermore, in the mobile robot 100, when highly reliable information of the obstacle cannot be acquired, the technique in which the mobile robot 100 is moved slightly to redetect the obstacle can be employed, which allows more accurate map data to be generated.

Next, the second embodiment is described.

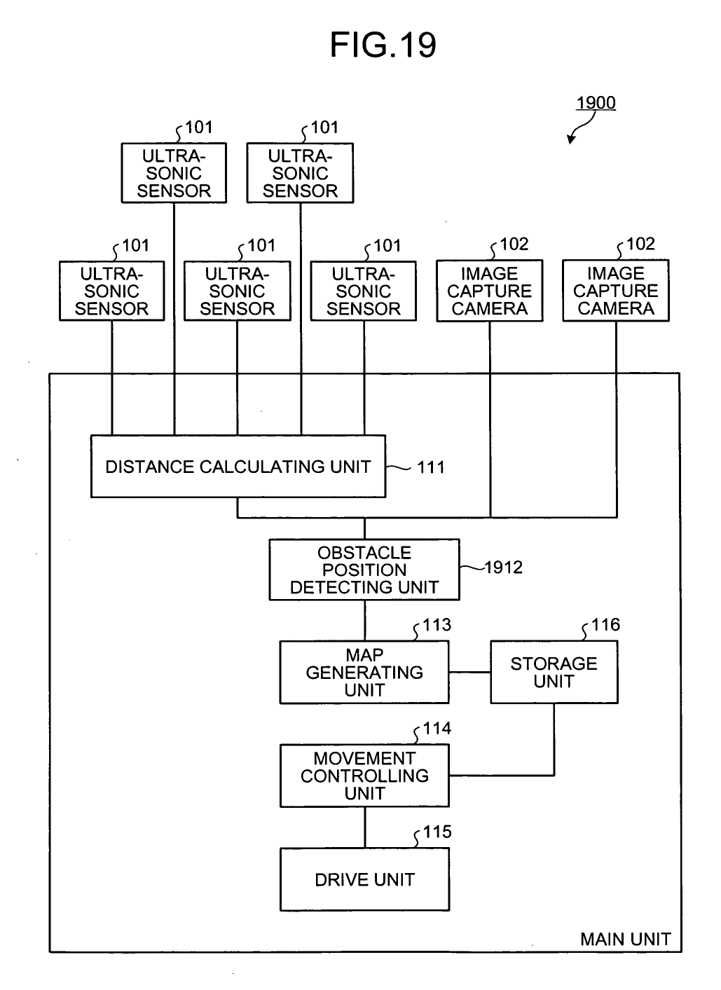

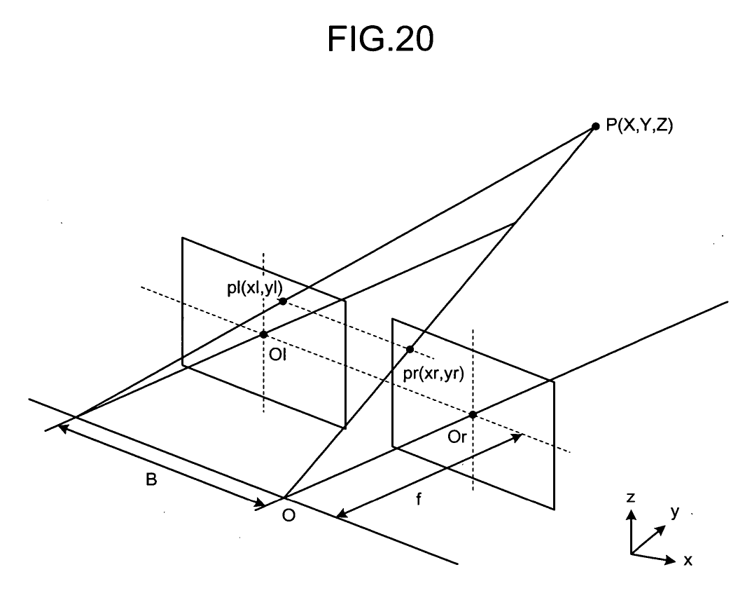

In a mobile robot 1900 shown in FIG. 19 according to the second embodiment, a disparity in a stereo system is obtained from two pieces of image data captured by the two image capture cameras 102, and based on the obtained disparity, a search range of an obstacle on the image data is determined for the detection of the position of the obstacle within the search range.

The functional configuration of the mobile robot 1900 according to the second embodiment is similar to that of the first embodiment. Furthermore, the entire processing for the map data generation by the mobile robot 1900 according to the second embodiment is performed as in the first embodiment.

In the present embodiment, in the obstacle position detection processing described in FIG. 5, the processing for determining the search range in step S502 is differently performed by an obstacle position detecting unit 1912 from that in the first embodiment in that the disparity is obtained from the two pieces of image data to determine the search range.

Namely, in the present embodiment, the two image capture cameras 102 are used as a stereo camera, and, a difference in X coordinates of the edges of the corners in the respective image data captured by the image capture cameras 102 is treated as being equivalent to the disparity in the stereo system.

If a distance to the corner position to be obtained is Dc, a distance to the front wall 600a obtained by the ultrasonic sensor is Df and a distance to the side wall 600b is Ds, for these distances, the following equations (4), (5) are established.
D_{c}²=D_{f}²+Dₛ² (4)
D_{c}=\sqrt{D_{f}²+Dₛ²} (5)

In practice, an error is included in the distances obtained from the sensor data of the ultrasonic sensors 101, and thus, when a difference E expressed by equation (6) is equal to, or less than a predetermined threshold, equations (4), (5) could be established.
E=|D_{f}²+Dₛ²·D_{c}²| (6)

Since the two image capture cameras 102 are arranged apart from each other at an arbitrary distance, the appearances of the corner from the respective image capture cameras 102 are different, and in some cases, an image of the corner cannot be observed by one of the image capture cameras 102. In such cases, the use of equations (4), (5) enables the specification of the corner position.

More specifically, in the determination processing of the search range in step S502, the distance Dc to the corner is calculated from the approximate value of the distances Df and Ds calculated by the ultrasonic sensors 101. Then, a disparity d of the corner position between Dc and the two pieces of image data is calculated.

FIG. 20 is a schematic diagram showing a relation between the image capture cameras 102 and a point P on the corner (X, Y, Z). From FIG. 20, the disparity d and positions of an obstacle in the two pieces of image data (xr, xl) can be obtained by the following equations (7) to (11).
Z=Df=B*f/d (7)

Namely, equation (7) is converted to obtain equation (8).
d=B*f/Df=xl−xr (8)
X=Ds=B*f*xr (9)

Furthermore, equation (9) is converted to obtain equation (10).
xr=Ds/(B*f) (10)

Then, equation (11) is obtained from equations (8) and (10),
xl=B*f/Df+Ds/(B*f) (11)
wherein B is a distance between the image capture cameras, f is a focal length of the image capture cameras, and d is a disparity.

Accordingly, if the disparity d is obtained, a predicted value of the X-coordinate of the corner in the image data in which the corner detection has been failed can be calculated from the X coordinate xr of the corner in the image data in which the corner has been detected and the disparity d. Therefore, a predetermined range centering the predicted value of the X-coordinate of the corner in the image data in which the corner detection has been failed is determined as the search range, and the edge detection similar to the processing in step S503 and later of the first embodiment is performed to thereby detects the position of the corner.

Also, for an obstacle other than a corner, the position detection is enabled by the processing of determining the search range utilizing the above-described disparity.

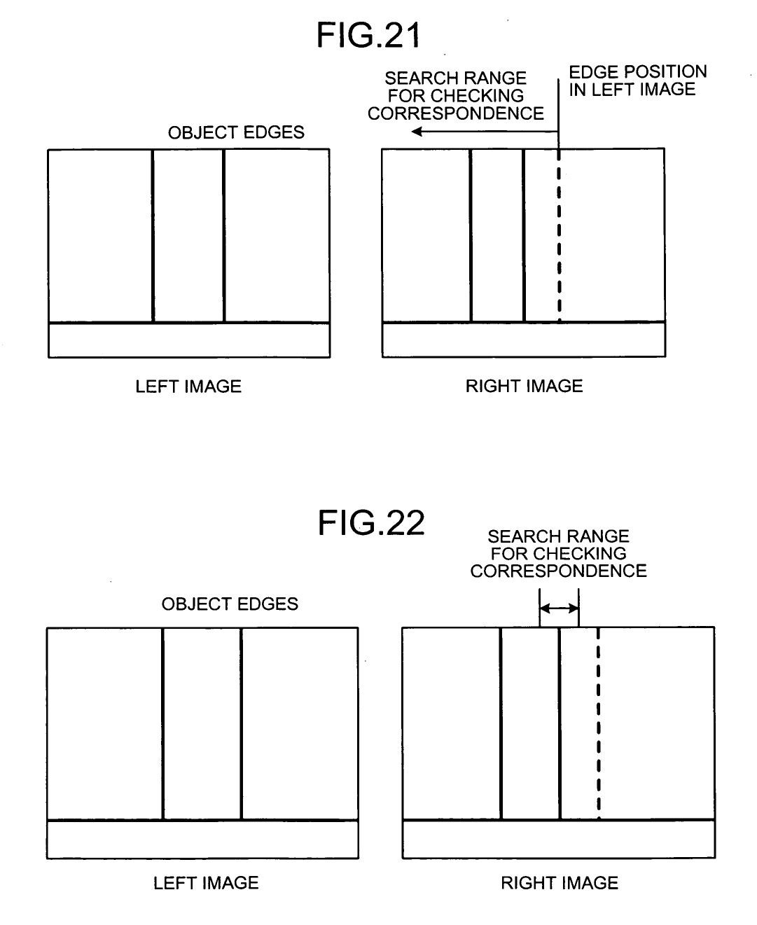

FIGS. 21 and 22 are schematic diagrams showing the states of the obstacle detection when the search range is determined utilizing the disparity. For example, if an edge as shown in FIG. 21 is acquired from the image data of the left image capture camera 102, in the right image data, a range that covers a leftward region from a value of the X-coordinate of the edge obtained in the left image data as a starting point is determined as the search range. Further, an edge with strength equal to, or higher than a predetermined threshold is searched for within the search range, and the obtained edge is specified as an obstacle.

In the example of FIG. 21, there are two edges that can correspond to the obstacle within the search range, and from the two edges, the edge whose characteristics are closer to the characteristics of the edge in the left image data is selected and specified as the obstacle. More specifically, for example, from the two edges, the edge in which a difference between the strength thereof and the strength of the edge of the left image data is equal to, or lower than a predetermined threshold is selected as one having the characteristics closer to those of the edge of the left image data and specified as the obstacle. For this threshold, different values between the inside and the outside of the search range are used.

Here, in the case where there is a repetition pattern like regularly-arrayed pillars, any edge has almost equal characteristics, and thus, it is difficult to obtain proper correspondence. In this case, the sensor data obtained from the ultrasonic sensors 101 is utilized and based on the distances obtained by the sensor data, the search range where the edge exists is determined as shown in FIG. 22. In the example of FIG. 22, only one of the candidates of the two edges is included in the search range. Therefore, the edge within such a search range is specified as the obstacle.

Thus, in the mobile robot 1900 according to the second embodiment, the disparity in the stereo system is obtained from the two pieces of image data captured by the two image capture cameras 102, and based on the disparity, the search range of the obstacle is determined on the image data to detect the position of the obstacle within the search range. Therefore, the search range can be determined more accurately, and even a weak edge that could not be found in the uniform processing to the entire image, or the like can be easily detected as long as it strongly appears in either of the two pieces of image data. Therefore, according to the mobile robot of the second embodiment, the position detection of an object such as an obstacle can be performed with high accuracy. Furthermore, as a result, in the mobile robot 1900 according to the second embodiment, a high accuracy map of the surrounding region can be created.

Next, the third embodiment is described.

While in the first and second embodiment, the mobile robot having the movement control mechanism is described as an example, in the third embodiment, the present invention is applied to a map creating apparatus that is a fixed apparatus without the movement mechanism, or to a map creating apparatus attached to a table whose movement is controlled by a human. In the map creating apparatus according to the third embodiment, the data obtained by a plurality of types of sensors is integrally used, which allows a high accuracy map to be generated.

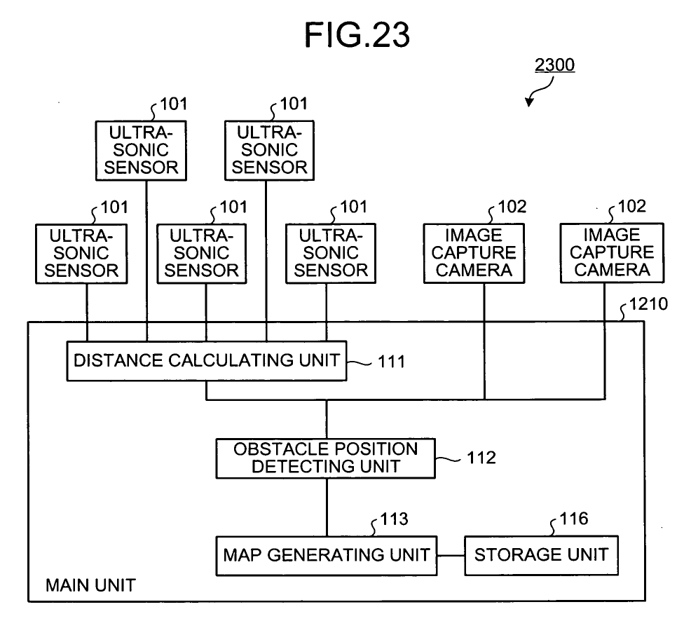

FIG. 23 is a block diagram showing a configuration of the map creating apparatus according to the third embodiment. A map creating apparatus 2300 according to the present embodiment, as shown in FIG. 23, mainly includes a main unit 1210, the five ultrasonic sensors 101 as range sensors connected to the main unit 1210, and the two image capture cameras 102 as image capture units. The functions and the configurations of the ultrasonic sensors 101 and the image capture cameras 102 are similar to those of the first embodiment.

As shown in FIG. 23, the main unit 1210 includes the distance calculating unit 111, the obstacle position detecting unit 112, the map generating unit 113 and the storage unit 116, and unlike the movement robots of the first and the second embodiments, the main unit 1210 does not include a movement mechanism such as the movement controlling unit and the drive unit.

The configurations and the functions of the respective units in the main unit 1210 are the same as the configurations and the functions of the respective units in the mobile robot of the first embodiment. The obstacle position detecting unit 112 determines a search range (candidate region) which is a region on image data having a possibility that an obstacle exists, based on the approximate values of the distances calculated by the distance calculating unit 111 and the above-described image data within the movement region whose images are captured by the image capture units 102, and detects the position of the obstacle from the image data using a threshold varied between the inside of search range and the outside thereof. As in the first embodiment, the map generating unit 113 acquires the position of the obstacle detected by the obstacle position detection unit 112 in chronological order, performs processing such as correction of the acquired position information to ensure the consistency, generates map data of the vicinity of its own position on which the consistent position information is reflected, and stores the generated map data in the storage unit 116.

The map generation processing and the obstacle position detection processing in the map creating apparatus according to the third embodiment are performed in a similar manner to the map generation processing and the obstacle position detection processing of the first and the second embodiments. Accordingly, in the map creating apparatus 2300 according to the third embodiment, since the position detection of an object such as an obstacle can be performed with higher accuracy as in the first and the second embodiments, a high accuracy map of the surrounding region can be created.

Next the fourth embodiment is described.

While the apparatuses of the first to the third embodiments each have the function of generating a map of the surrounding region thereof from the detected position of the obstacle, in the fourth embodiment, there is provided an obstacle position detecting apparatus that detects a position of an obstacle by integrally utilizing sensor information, which can be used as an obstacle detecting apparatus mountable on an automobile or the like. The obstacle position detecting apparatus according to the present embodiment does not have the function of generating map data from the position information of the obstacle but the position information itself of the obstacle obtained in chronological order is utilized as final output.

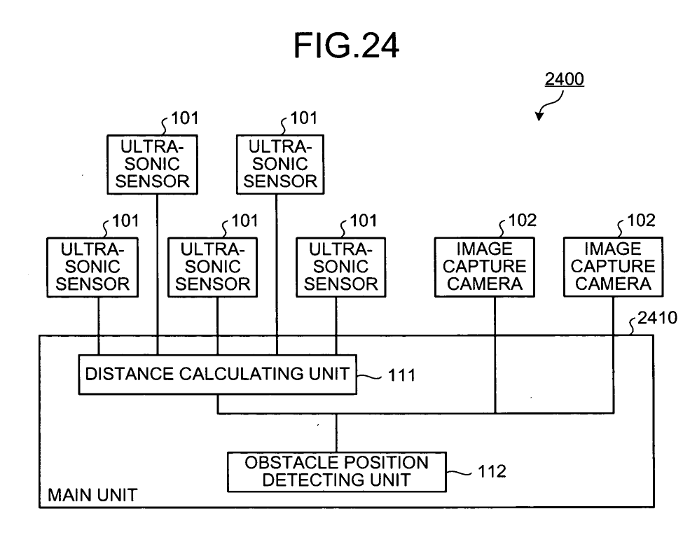

FIG. 24 is a block diagram showing a configuration of the obstacle position detecting apparatus according to the fourth embodiment. An obstacle position detecting apparatus 2400 of the present embodiment, as shown in FIG. 24, mainly includes a main unit 2410, the five ultrasonic sensors 101 as the range sensors connected to the main unit 2410 and the two image capture cameras 102 as the image capture units. The functions and the configurations of the ultrasonic sensors 101 and the image capture cameras 102 are similar to those of the first embodiment.

As shown in FIG. 24, the main unit 2410 includes the distance calculating unit 111 and the obstacle position detecting unit 112, and unlike the mobile robots of the first and the second embodiments and the map creating apparatus of the third embodiment, the main unit 2410, has a configuration in which the map generating mechanism such as the map generating unit and the storage unit is not included. Furthermore, unlike the mobile robots of the first and the second embodiments, it is configured so that the mobile mechanism such as the movement controlling unit and the drive unit is not included.

The configurations and the functions of the respective units of the main unit 2410 are similar to those of the respective units in the mobile robot of the first embodiment, and the obstacle position detecting unit 112 determines a search range (candidate region) using the approximate value of the distance calculated by the distance calculating unit 111 and the image data captured by the image capture unit 102 from the movement region. The search range is a region, which appears in the image data captured by the image capture unit 102, and in which an obstacle is expected to exist. Then, the obstacle position detecting unit 112 detects the position of the obstacle from the image data using thresholds varied between the inside and the outside of search range, and outputs the detected position information of the obstacle.

The obstacle position detection processing in the obstacle position detecting apparatus according to the fourth embodiment is performed in a similar manner to the obstacle position detection processing of the first and the second embodiments. Accordingly, in the obstacle position detecting apparatus 2400 according to the fourth embodiment, as in the first and the second embodiments, the position detection of an object such as an obstacle can be performed with higher accuracy.

While in the above-described embodiments, a description is given, exemplifying the position detection of an obstacle as an object, the present invention can also be applied to the position detection of an object other than the obstacle.

A map generating program and a position detecting program executed in the mobile robots 100 and 1900, the map creating apparatus 2300, and the obstacle position detecting apparatus 2400 of the above-described embodiments are provided by being incorporated into ROM or the like in advance. The map generating program and the position detecting program executed in the mobile robots 100 and 1900, the map creating apparatus 2300, and the obstacle position detecting apparatus 2400 of the above-described embodiments may be structured so as to be provided by being recorded on a computer-readable recording medium such as a Compact Disk Read-only-Memory (CD-ROM), a flexible disc (FD), a Compact Disk Recordable (CD-R) and a Digital Versatile Disk (DVD) in a file in an installable format or an executable format. Furthermore, the map generating program and the position detecting program executed in the mobile robots 100 and 1900, the map creating apparatus 2300, and the obstacle position detecting apparatus 2400 according to the above described embodiments may be structured so as to be stored on a computer connected to a network such as the Internet and downloaded and provided via the network. Furthermore, the map generating program and the position detecting program may be structured so as to be provided or delivered via the network such as the Internet.

The map generating program and the position detecting program executed in the mobile robots 100 and 1900, the map creating apparatus 2300, and the obstacle position detecting apparatus 2400 of the above-described embodiments each have a module configuration including the above-described units, and as actual hardware, a CPU (processor) reads and executes the map generating program and the position detecting program from the above-mentioned ROM to load the above-described units on a main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An object position detecting apparatus comprising:
range sensors, each sensing an object within a sensing region and obtaining an object information indicating existence of the object;
image capturing units, each capturing an image data for the sensing region;
a distance calculating unit that calculates approximate values of distances from the respective range sensors to the object using the object information; and
a position determing unit that determines a candidate region where the object exists in the image data based on the approximate values of the distances, and determines a position of the object in the image data by performing image processing of the image data and evaluating a result of the image processing based on a different predetermined threshold between an inside and an outside of the candidate region.

2. The apparatus according to claim 1, wherein the position determining unit changes the candidate region determined when the position of the object cannot be determined in the image data, and performs image processing of the image data using the threshold within the candidate region changed to determine the position of the object.

3. The apparatus according to claim 2, wherein the position detecting unit further controls the threshold according to the position within the candidate region, and performs the image processing of the image data to detect the position of the object.

4. The apparatus according to claim 1, wherein
the distance calculating unit calculates the approximate values of the distances to wall surfaces which is sensed by the range sensors as obstacles; and
the position detecting unit sets the candidate region in the image data based on the approximate values of the distances, and detects a position of a corner which is a boundary between the different wall surfaces from the image data using the threshold varied between the inside and the outside of the candidate region.

5. The apparatus according to claim 4, wherein
the range sensors are a first sensor that senses an object in front of the object position detecting apparatus and a second range sensor that senses an object on the side of the object position detecting apparatus itself;
the distance calculating unit calculates an approximate value of a first distance to a wall surface sensed by the first range sensor and an approximate value of a second distance to a wall surface sensed by the second range sensor; and
the position detecting unit sets a predetermined range in an oblique direction between the first range sensor and the second range sensor as the candidate region in the image data and detects the position of the corner, using the threshold varied between the inside and the outside of this candidate region when a difference between the approximate value of the first distance and the approximate value of the second distance is in a predetermined range.

6. The apparatus according to claim 5, further comprising
a storage unit that stores inclination data in which a correlation between a ratio of the first distance to the wall surface in front of the object position detecting apparatus and the second distance to the wall surface on the side of the object position detecting apparatus and an oblique angle of the object position detecting apparatus with respect to the wall surface is set in advance, and position data in which a correlation between the oblique angle and the position of the corner in the image data is set in advance,
wherein the position detecting unit further sets the candidate region in the image data from the ratio of the approximate value of the first distance and the approximate value of the second distance, the inclination data, and the position data, and detects the position of the corner using the threshold varied between the inside and the outside of the candidate region.

7. The apparatus according to claim 4, wherein the position detecting unit detects an edge within the candidate region in the image data to thereby detect the position of the corner.

8. The apparatus according to claim 7, wherein when plural edges is detected within the candidate region, the position detecting unit detects the position of the corner from the plural edges based on characteristics of regions delineated by the edge on the image data.

9. The apparatus according to claim 8, wherein when plural edges is detected within the candidate region, the position detecting unit detects the position of the corner from the plural edges by a brightness difference between the regions delineated by the edge on the image data.

10. The apparatus according to claim 8, wherein when plural edges is detected within the candidate region, the position detecting unit detects the position of the corner from the plural edges by a color difference between the regions delineated by the edge on the image data.

11. The apparatus according to claim 4, the position detecting unit, on failing to detect the position of the corner from the plural edges, further extends the candidate region in the image data to detect the corner using the threshold varied between the inside and the outside of the extended candidate region.

12. The apparatus according to claim 11, wherein the position detecting unit extends the candidate region in the image data vertically at the edge to detect the corner from upper and lower shapes of the edge.

13. The apparatus according to claim 1, wherein
the number of the image capture units is at least two; and
the position detecting unit further calculates a disparity from the two pieces of image data captured by the two image capture units, sets the candidate region in the image data based on this disparity, and detects the position of the object based on the image data and the approximate value of the distance using the threshold varied between the inside and the outside of the candidate region.

14. A map creating apparatus comprising:
range sensors, each sensing an object within a sensing region and obtaining an object information indicating existence of the object;
image capturing units, each capturing an image data for the sensing region;
a distance calculating unit that calculates approximate values of distances from the respective range sensors to the object using the object information;
a position determing unit that determines a candidate region where the object exists in the image data based on the approximate values of the distances, and determines a position of the object in the image data by performing image processing of the image data and evaluating a result of the image processing based on a different predetermined threshold between an inside and an outside of the candidate region; and
a map generating unit that generates map data of a vicinity of a position of the map creating apparatus by ensuring consistency of the position of the object detected by the position detecting unit as time series.

15. An autonomous mobile apparatus comprising:
range sensors, each sensing an object within a sensing region and obtaining an object information indicating existence of the object;
image capturing units, each capturing an image data for the sensing region;
a distance calculating unit that calculates approximate values of distances from the respective range sensors to the object using the object information;
a position determing unit that determines a candidate region where the object exists in the image data based on the approximate values of the distances, and determines a position of the object in the image data by performing image processing of the image data and evaluating a result of the image processing based on a different predetermined threshold between an inside and an outside of the candidate region; and
a movement controlling unit that controls a movement of the autonomous mobile apparatus so as to avoid the object, based on the position of the object detected by the position detecting unit as time series.

16. An autonomous mobile apparatus comprising:
range sensors, each sensing an object within a sensing region and obtaining an object information indicating existence of the object;
image capturing units, each capturing an image data for the sensing region;
a distance calculating unit that calculates approximate values of distances from the respective range sensors to the object using the object information;
a position determing unit that determines a candidate region where the object exists in the image data based on the approximate values of the distances, and determines a position of the object in the image data by performing image processing of the image data and evaluating a result of the image processing based on a different predetermined threshold between an inside and an outside of the candidate region;
a map generating unit that generates map data of a vicinity of a position of the autonomous mobile apparatus by ensuring consistency of the position of the object detected by the position detecting unit as time series; and
a movement controlling unit that controls a movement of the autonomous mobile apparatus so as to avoid the object, based on the map data generated by the map generating unit.

17. An object position detecting method which is performed by an apparatus comprising:
calculating approximate values of distances to an object sensed by range sensors each sensing the object within a sensing region and obtaining an object information indicating existence of the object; and
determining a candidate region where the object exists in the image data by image capturing units each capturing the image data for the sensing region, based on the approximate values of the distances, and determining a position of the object in the image data by performing image processing of the image data and evaluating a result of the image processing based on a different predetermined threshold between an inside and an outside of the candidate region.

18. A computer program product having a computer readable medium including programmed instructions for object position detection which is performed by an apparatus, wherein the instructions, when executed by a computer, cause the computer to perform:
calculating approximate values of distances to an object sensed by range sensors each sensing the object within a sensing region and obtaining an object information indicating existence of the object; and
determining a candidate region where the object exists in the image data by image capturing units each capturing the image data for the sensing region, based on the approximate values of the distances, and determining a position of the object in the image data by performing image processing of the image data and evaluating a result of the image processing based on a different predetermined threshold between an inside and an outside of the candidate region.
